(19) United States
(12) Patent Application Publication
(10) Pub. No.: US 2020/0309274 A1
(43) Pub. Date: Oct. 1, 2020

(54) DIAPHRAGM VALVE

(71) Applicant: FUJIKIN INCORPORATED, Osaka-shi (JP)

(72) Inventors: Shunji Obara, Osaka-shi (JP); Tadayuki Yakushijin, Osaka-shi (JP); Takayuki Higuchi, Osaka-shi (JP)

(73) Assignee: FUJIKIN INCORPORATED, Osaka-shi (JP)

(21) Appl. No.: 16/649,790

(22) PCT Filed: Sep. 20, 2018
(86) PCT No.: PCT/JP2018/034935

§ 371 Date: Mar. 23, 2020

(30) Foreign Application Priority Data
Sep. 25, 2017 (JP) 2017-184195

(51) Int. Cl. F16K 7/12

(52) U.S. Cl. CPC F16K 7/123

(57) ABSTRACT

The diaphragm valve comprises a body with a flow path, a stem, a diaphragm, a diaphragm depressor attached to the lower end of the stem, and a connecting member which connects the diaphragm and the diaphragm depressor. Further, the connecting member has a rod-shaped part to be connected to the diaphragm depressor and a flange part which is radially protruding in a circular shape at the lower end of the connecting member and having at least one notch on the outer peripheral edge. Furthermore, the rod-shaped part has a radially concaved constriction part above the flange part, and the flange part and the constriction part are embedded in the central part of the diaphragm.

### BACKGROUND OF THE INVENTION

The present invention relates to a diaphragm valve having a connecting member which connects a diaphragm to a diaphragm depressor.

Conventionally, Japanese Patent No. 3027450 discloses a diaphragm valve, which closes a flow path by pressing a diaphragm from above with a diaphragm depressor and deforming it.

Such a diaphragm valve mainly comprises a body with a flow path, a stem movable up and down relative to the body, a diaphragm which opens and closes the flow path, and a diaphragm depressor which is attached to the lower end of the stem and presses the diaphragm downward.

For example, as shown in FIG. 8, a diaphragm (31) is connected to a diaphragm depressor (33) by a connecting bolt (32). Specifically, the upper part of the connecting bolt (32) is fixed to the diaphragm depressor (33), and a flange part (34) formed at the lower end of the connecting bolt (32) is embedded in the central part (35) of the diaphragm (31). Therefore, the central part (35) of the diaphragm (31) is connected to the diaphragm depressor (33) via the connecting bolt (32), and can follow the up-and-down movement of the diaphragm depressor (33).

However, as for a conventional diaphragm valve like above, when a high load is applied to the diaphragm (31) or the connecting bolt (32), the diaphragm (31) covering the upper part of the flange part (34) of the connecting bolt (32) may turn over or get broken, possibly causing the diaphragm (31) to come off from the connecting bolt (32).

Here, in order to prevent the diaphragm (31) from coming off, proposals have been made previously to provide the flange part (34) with a through-hole and insert therein a resin which constitutes the diaphragm (31), which would increase the connecting force between the diaphragm (31) and the connecting bolt (32). However, in case of a small diaphragm valve, it is difficult to provide the flange part (34) with a through-hole which is effective enough to prevent the detachment.

### SUMMARY OF THE INVENTION

The present invention aims to provide a diaphragm valve with an increased effect of preventing the diaphragm from coming off from the connecting member in order to solve the above-mentioned problems of the conventional technology.

The diaphragm valve of the present invention is a diaphragm valve comprising:
a body with a flow path;
a stem;
a diaphragm;
a diaphragm depressor attached to the lower end of the stem; and
a connecting member which connects the diaphragm and the diaphragm depressor,
the diaphragm valve being able to open and close shutting off the flow path by deformation of the diaphragm, wherein the connecting member has a rod-shaped part to be connected to the diaphragm depressor and a flange part which is radially protruding in a circular shape at the lower end of the connecting member and having at least one notch on the outer peripheral edge, and the rod-shaped part has a radially concaved constriction part above the flange part, and
wherein the flange part and the constriction part are embedded in the central part of the diaphragm.

The flange part may be referred to as a bigger diameter part, as the diameter thereof is bigger than that of the rod-shaped part.

The constriction part may be referred to as a smaller diameter part, as the diameter thereof is smaller than that of the rod-shaped part.

Assuming that the diameter of the rod-shaped part is D₁ and that the diameter of the flange part is D₂, the diameter of the flange part, D₂, can range from 1.1D₁ to 1.4D₁.

Assuming that the diameter of the rod-shaped part is D₁ and that the diameter of the constriction part is D₃, the diameter of the constriction part, D₃, can range from 0.9D₁ to 0.7D₁.

As mentioned later, it is also possible to have both the flange part and the constriction part embedded in the central part of the diaphragm.

The diaphragm valve of the present invention has at least one flange part and at least one constriction part, too.

As mentioned later, it is preferable that more than one notches are provided and that they are arranged at nearly equal interval at a circumferential angle.

Another form of the diaphragm valve of the present invention comprises, a body with a flow path, a stem moveable up and down relative to the body, a diaphragm which opens and closes the flow path in synchronization with the up-and-down movement of the stem, a diaphragm depressor which is attached to the lower end of the stem and presses the diaphragm downward, and a connecting member which connects the central part of the diaphragm to the lower part of the diaphragm depressor, wherein the connecting member has a vertically placed rod-shaped part whose upper part is fixed to the diaphragm depressor and a flange part which is provided at the lower end of the rod-shaped part and protrudes radially outward of the outer peripheral surface of the rod-shaped part, wherein the upper part of the flange part at the lower end of the rod-shaped part has a constriction concaved radially inward, wherein the outer peripheral edge of the flange part has at least one notch, wherein the lower end of the rod-shaped part and the flange part of the connecting member are embedded in the central part of the diaphragm, and wherein the component of the central part of the diaphragm is configured to cover both the upper and lower surfaces of the flange part by entering inside the constriction part of the rod-shaped part and the notch(es) of the flange part.

In a configuration having a connecting member to connect the diaphragm to the lower part of the diaphragm depressor, the diaphragm valve of the present invention has a structure which effectively can prevent the flange part of the connecting member embedded in the central part of the diaphragm from coming off therefrom.

Specifically, a notch is provided on the outer peripheral surface of the flange part of the connecting member, and a constriction part is provided on the rod-shaped part of the connecting member. In this structure, with the lower end of the rod-shaped part and the flange part of the connecting member embedded in the central part of the diaphragm, the component of the central part of the diaphragm is configured to cover both the upper and lower surfaces of the flange part by entering inside the constriction part of the rod-shaped part and the notch(es) of the flange part. As a result, the component of the central part of the diaphragm enlarges the area covering the upper surface of the flange part by the amount of the component entering the constriction part, and in addition, the component entering inside the notch(es) connects the components covering the upper and lower surfaces of the flange part. Therefore, the component entering the constriction part is connected with the component inside the notches further inside than the periphery of the flange part, making the detachment from the constriction part less likely to happen. Furthermore, the component entering inside the notch(es) regulates relative rotation of the flange part and the diaphragm. As a result, it is possible to effectively prevent the flange part from coming off from the central part of the diaphragm and then the diaphragm from coming off from the connecting member.

In addition, providing the lower end of the rod-shaped part with the constriction part enables the notch(es) of the flange part to be formed more deeply in a radially inner direction of the flange part. Therefore, it becomes possible to connect the component entering the constriction part and the component entering the notch(es) in the component of the central part of the diaphragm in more vicinity to the axial center of the rod-shaped part and the flange part. As a result, it is possible to surely increase the retention force of the flange part, even for a small diaphragm valve where the outer diameters of the diaphragm and the flange part embedded therein are small.

The outer diameter of the flange part may be φ7.2-φ7.7 mm.

Even for a flange with its outer diameter above, providing the lower end of the rod-shaped part with the constriction part as above, enables the notch(es) of the flange part to be formed deeply in a radially inner direction of the flange part. Therefore, it becomes possible to connect the component entering the constriction part and the component entering the notch(es) in the component of the central part of the diaphragm in more vicinity to the axial center of the rod-shaped part and the flange part. As a result, even a small diaphragm valve with a small diaphragm, where the outer diameter of the flange part embedded in the diaphragm is φ7.2-φ7.7 mm, can easily increase the retention force of the flange part.

The notch preferably has a semi-circular shape.

In such a configuration, as the notch(es) formed on the outer peripheral edge of the flange part is/are semi-circular shaped and made up of a smooth arc-shaped inner peripheral surface, the component of the central part of the diaphragm can enter inside the notch(es) smoothly without any gap.

Therefore, it is possible to surely increase the retention force of the flange part and reduce variability in performance of the diaphragm valve.

The flange part preferably has a shape where the central part of its lower surface bulges downward.

In such a configuration, as the central part of the lower surface of the flange part bulges downward, when the diaphragm closes the flow path and the connecting member is lowered, the pressing force applied by the flange part to the central part of the diaphragm is not concentrated on the outer peripheral edge of the flange part, but can be distributed extensively inside the central part. Therefore, it is possible to reduce the risk of deterioration and breakage of the diaphragm.

The component of the central part of the diaphragm preferably is configured to cover the upper part of the constriction part of the rod-shaped part.

As the component of the central part of the diaphragm is configured to cover the upper part of the constriction part of the rod-shaped part, it becomes possible to increase the thickness of the component of the central part of the diaphragm which is configured to cover the upper part of the flange, and it enables to further increase the retention force of the flange part.

According to the diaphragm valve of the present invention, the effect of preventing a diaphragm from coming off from the connecting member can be increased.

### BRIEF EXPLANATION OF THE DRAWINGS

FIG. 1 It is a cross-sectional view showing an overall structure of the diaphragm valve according to an embodiment of the present invention, cut along the direction in which the flow path extends.

FIG. 2 It is a cross-sectional view showing an overall structure of the diaphragm valve according to an embodiment of the present invention, cut along the direction crossing the flow path.

FIG. 3 It is a perspective view of the hook (connecting member) in FIG. 1.

FIG. 4 It is an illustrative cross-sectional view showing the connected state of the diaphragm, the diaphragm depressor, and the hook in FIG. 1.

FIG. 5 It is a perspective view of the hook according to another embodiment of the present invention.

FIG. 6 It is an illustrative cross-sectional view showing the connected state of the diaphragm, the diaphragm depressor, and the hook according to another embodiment of the present invention.

FIG. 7 It is an illustrative cross-sectional view showing the connected state of the diaphragm, the diaphragm depressor, and the hook according to yet another embodiment of the present invention.

FIG. 8 It is a drawing showing the connected state of a diaphragm, a diaphragm depressor, and a hook of a conventional diaphragm valve.

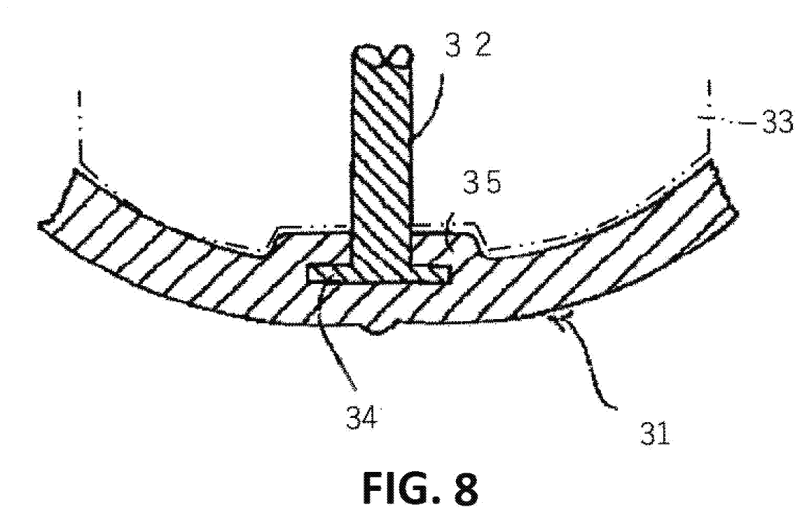

### DETAILED DESCRIPTION OF EXAMPLE EMBODIMENTS

Next, embodiments of a diaphragm valve of the present invention are described in more detail with reference to the drawings.

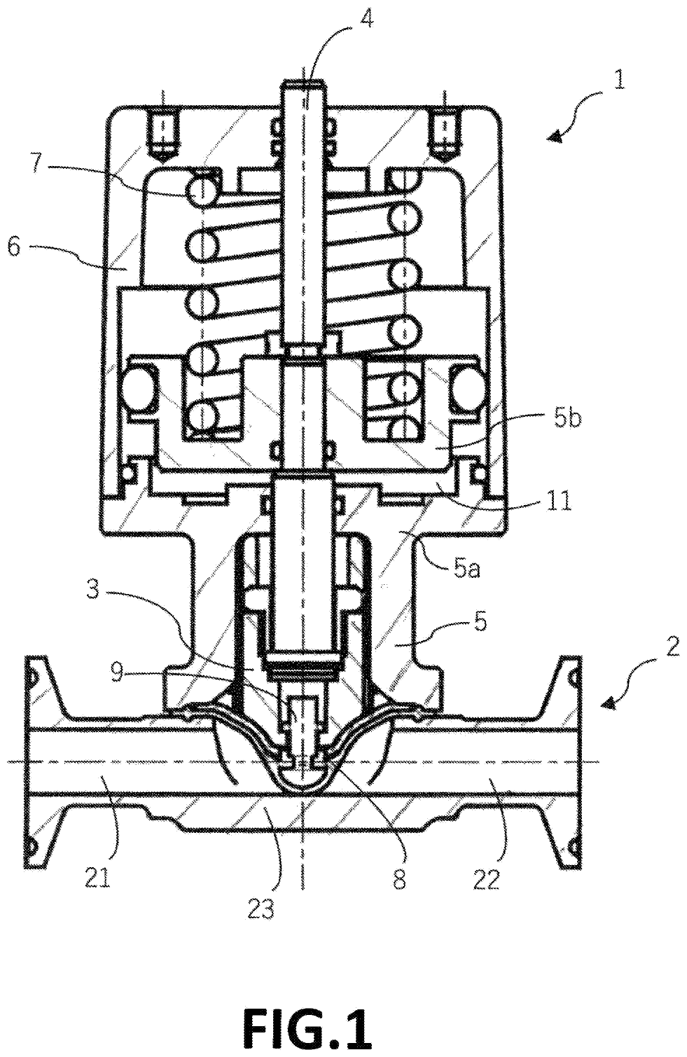

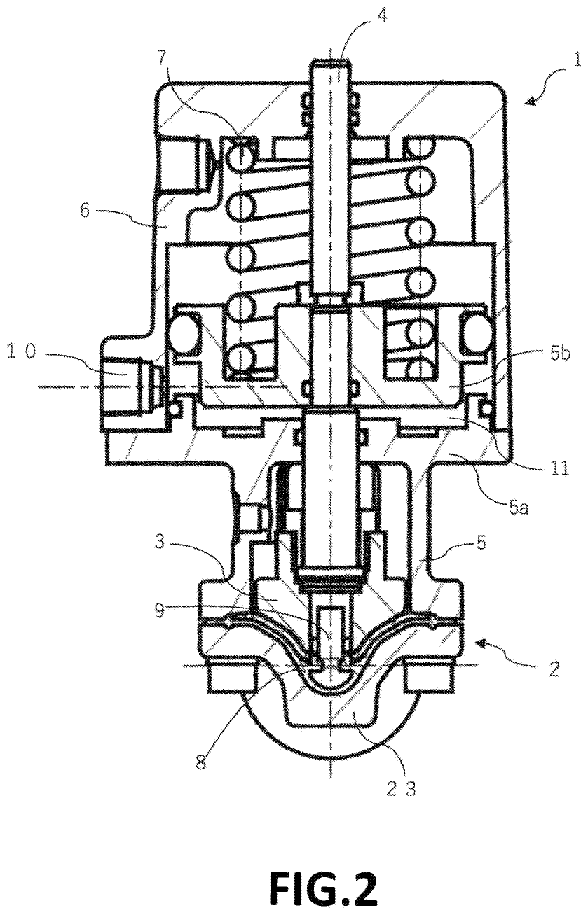

As shown in FIGS. 1-2, a diaphragm valve (1) comprises a valve body (2) with a flow path (21), (22), a stem (4), an upper case (5), a diaphragm (8), a diaphragm depressor (3), and a hook (9) (connecting member) that hangs the diaphragm (8) from the diaphragm depressor (3).

The valve body (2) is a cylindrical member extending horizontally and comprises the above flow path (21), (22) and a seat part (23) which is located in the middle of the flow path (21) and (22) and is shaped being able to abut on the diaphragm when the diaphragm (8) is in the lower position.

The stem (4) is received in the upper case (5) attached to the upper part of the valve body (2), so that it can move up and down relative to the valve body (2).

The upper case (5) has a fixed part (5a) secured to the upper part of the valve body (2) and a moveable part (5b). The movable part (5b) is received so as to be vertically movable inside an actuator cap (6), and is constantly biased downward by a spring (7). There is an air passage (11) formed between the fixed part (5a) and the movable part (5b). Regarding the air passage (11), the movable part (5b) goes up due to the pressure of the air fed from the inlet port (10) into the air passage (11). This allows the stem (4) connected to the movable part (5b) to go up against the biasing force of the spring (7).

The diaphragm depressor (3) is a member that presses the diaphragm (8) downward, and is attached to the lower end of the stem (4) and moves up and down together with the stem (4).

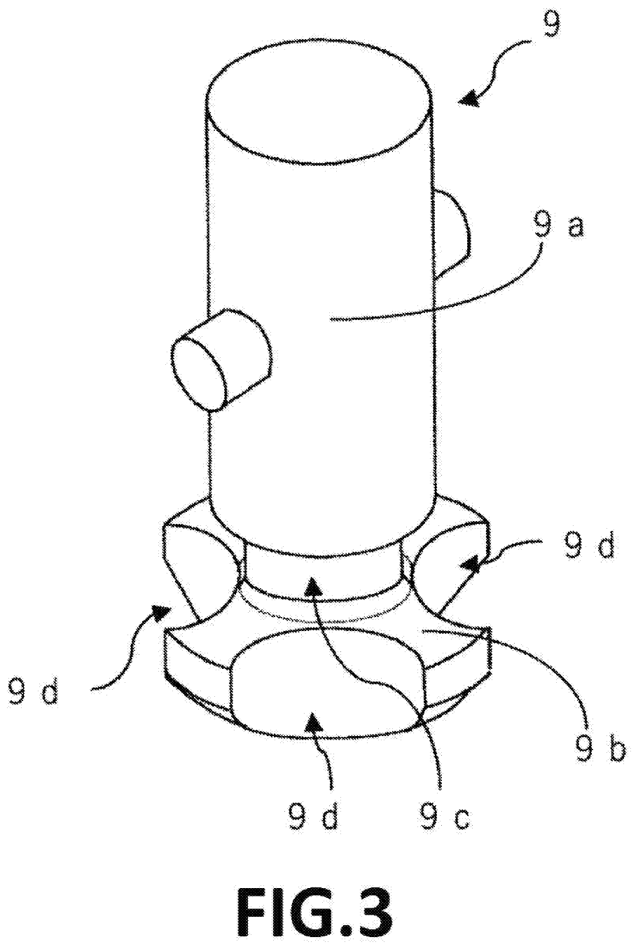

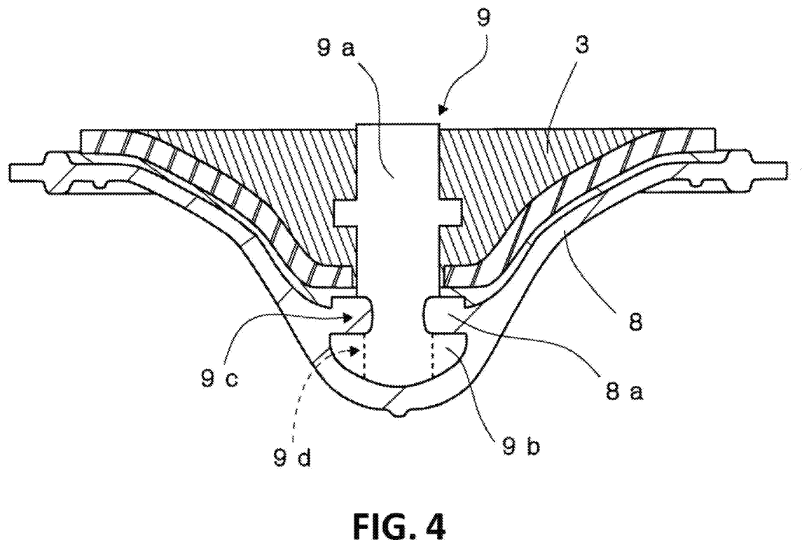

A diaphragm (8) is a deformable sheet-like member and integrally molded (insert molded, for example) together with the hook (9), so that the after-mentioned flange part (9b) of the hook (9) (See FIG. 3-4) can be embedded in the central part (8a).

The diaphragm (8) is made of a flexible member such as synthetic resin or synthetic rubber and manufactured from, for example, PTFE, butyl rubber, fluoro-rubber etc. Particularly, PTFE is preferable because it is superior in strength etc. to fluoro-rubber or the like.

The diaphragm (8) is attached so as to close an opening formed on the upper wall of the valve body (2), so that the diaphragm (8) can appear in the middle of the flow path (21), (22). The outer periphery of the diaphragm (8) is airtightly closed by being sandwiched between the upper case (5) and the valve body (2).

The diaphragm (8) opens and closes the flow path (21), (22) in the valve body (2) by appearing in the flow path (21), (22) in synchronization with the up-and-down movement of the stem (4).

As shown in FIGS. 3-4, the hook (9) is a connecting member which connects the central part (8a) of the diaphragm (8) to the lower part of the diaphragm depressor (3). The hook (9) connects the diaphragm (8) to the diaphragm (3) depressor by hanging the diaphragm (8) on the diaphragm depressor (3), and thus, is referred to as a hanging bracket.

The hook (9) comprises a rod-shaped part (9a) extending vertically and a flange part (9b) provided at the lower end of the rod-shaped part (9a). The hook (9) is manufactured by integrally molding the rod-shaped part (9a) and the flange part (9b) with a metallic material, such as stainless steel.

The upper part of the rod-shaped part (9a) may be fixed being hooked on the diaphragm depressor (3) or fixed being screwed in with a part called sleeve. For example, the rod-shaped part (9a) shown in FIGS. 3-4 has a pair of protrusions which are extending horizontally and engaged with the diaphragm depressor (3) to get the rod-shaped part (9a) caught in the diaphragm depressor (3), however, another fixation structure may be used too.

The rod-shaped part (9a) is placed along the vertical direction. The rod-shaped part (9a) is a cylindrical rod, for example, but it may have another cross-section (rectangular section, for example).

Above the flange part (9b) at the lower end of the rod-shaped part (9a) is provided a constriction part (9c) that is concaved radially inward. In the present embodiment, the constriction part (9c) is formed like a circular groove running along the entire periphery of the lower end of the cylindrical rod-shaped part (9a), but the present invention is not limited to this. The constriction part (9c) can be formed at a part of the lower end of the rod-shaped part (9a), for example, in vicinity to the notch(es) (9d) on the after-mentioned flange part (9b).

The flange part (9b) is a member provided at the lower end of the rod-shaped part (9a) and protrudes radially outward of the outer peripheral surface of the rod-shaped part (9a). In the present embodiment, the flange part (9b) has a disc shape, but the present invention may include, but not limited to, rectangular and polygonal shapes (such as hexagonal shape).

Further, the flange part (9b) in the present embodiment, as shown in FIG. 3-4, has a shape in which the central part (8a) of the lower surface bulges downward.

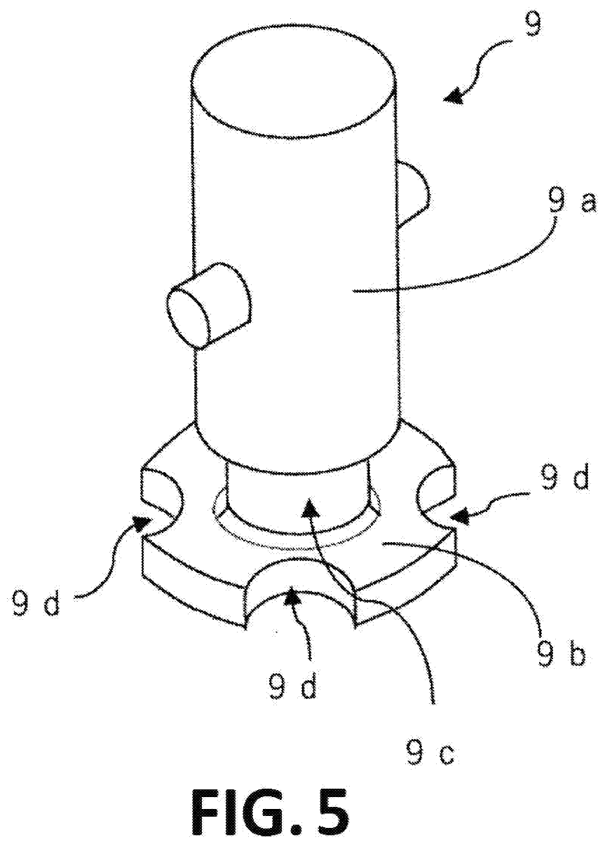

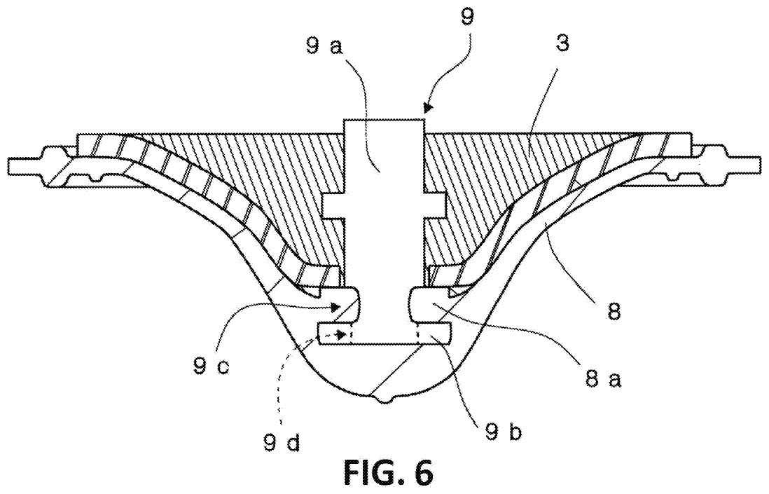

In another embodiment of the present invention, as shown in FIGS. 5-6, the flange part (9b) may have a flat disk-shape on both the upper and lower surfaces. In that case too, the flange part (9b) may have at least one (four in FIGS. 5-6) notch (9d) formed at the outer peripheral edge of the flange part (9b).

The outer diameter of the flange part (9b) may be arbitrary set according to the specification etc. of the diaphragm valve (1), but in case of a small diaphragm valve (1), for example (with the diaphragm valve (1) having a diaphragm (8) with its outer diameter 40-50 mm, for example), it is φ97.2 to φ7.7 mm.

At the outer peripheral edge of the flange part (9b) is formed at least one notch. In the present embodiment, four notches (9d) are formed along the outer peripheral edge of the flange part (9b) at equal intervals. While the notches (9d) in the present embodiment have a semi-circular shape, the present invention may include, but not limited to, another shape (such as a triangle shape).

In the central part (8a) of the diaphragm (8) are embedded the lower end of the rod-shaped part (9a) and the flange part (9b) of the hook (9).

The component (PTFE, for example) of the central part (8a) of the diaphragm (8) is configured to cover both the upper and lower surfaces of the flange part (9b) by entering inside the constriction part (9c) of the rod-shaped part (9a) and the notches (9d) of the flange part (9b).

With the diaphragm valve (1) configured as mentioned above, in the normal state shown in FIGS. 1-2, a diaphragm (8) is at the lower position, abutting on the seat part (23) and closing the flow path (21), (22). In this closed state, the movable part (5b) of the upper case (5) is lowered by the biasing force of the spring (7), and at the same time, the stem (4) and the diaphragm depressor (3) fixed to the lower end of the stem are also lowered. Furthermore, the diaphragm depressor (3) presses the diaphragm (8) downward to push it down against the seat part (23).

On the other hand, to open the flow path (21), (22), air may be sent from the inlet port (10) into the air passage (11) at a predetermined pressure or above. At this time, due to the air pressure fed into the air passage (11), the movable part (5b) goes up against the biasing force by the spring (7), and at the same time, the stem (4) and the diaphragm depressor (3) go up. Furthermore, when the diaphragm depressor (3) goes up, the diaphragm (8) hanging thereon via the hook (9) also goes up while bending and moving upward away from the seat part (23) allowing the flow path (21), (22) to open.

In the present embodiment configured as above, the diaphragm valve (1) configured to have a hook (9) connecting the diaphragm (8) to the lower part of the diaphragm depressor (3), has a structure which effectively prevents the flange part (9b) of the hook (9) embedded in the central part (8a) of the diaphragm (8) from coming off therefrom.

Specifically, notches (9d) are provided on the outer peripheral surface of the flange part (9b) of the hook (9) and a constriction part (9c) is provided at the rod-shaped part (9a) of the hook (9).

In this structure where the lower end of the rod-shaped part (9a) and the flange part (9b) of the hook (9) are embedded in the central part (8a) of the diaphragm (8), the component (PTFE, for example) of the central part (8a) of the diaphragm (8) is configured to cover both the upper and lower surfaces of the flange part (9b), by entering inside the constriction part (9c) of the rod-shaped part (9a) and the notches (9d) on the flange part (9b). As a result, the component of the central part (8a) of the diaphragm (8) enlarges the area covering the upper surface of the flange part (9b) by the amount of the component entering the constriction part (9c), and in addition, the component entering inside the notches (9d) connects the components covering the upper and lower surfaces of the flange part (9b). Therefore, the component entering the constriction part (9c) is connected with the component inside the notches (9d) further inside than the periphery of the flange part (9b), making the detachment from the constriction part (9c) less likely to happen. Furthermore, the component entering inside the notches (9d) regulates relative rotation of the flange part (9b) and the diaphragm (8). As a result, it is possible to effectively prevent the flange part (9b) from coming off from the central part (8a) of the diaphragm (8) and then the diaphragm (8) from coming off from the hook (9).

In addition, providing the lower end of the rod-shaped part (9a) with the constriction part (9c) enables the notches (9d) of the flange part (9b) to be formed more deeply in the radially inner direction of the flange part (9b). Therefore, it becomes possible to connect the component entering the constriction part (9c) and the component entering the notches (9d) in the central part (8a) of the diaphragm (8) in more vicinity to the axial center of the rod-shaped part (9a) and the flange part (9b). As a result, it is possible to surely increase the retention force of the flange part (9b), even for a small diaphragm valve (1) where the outer diameters of the diaphragm (8) and the flange part (9b) embedded therein are small.

For example, as shown in FIGS. 5-6, using a diaphragm valve (1) in the present embodiment of the present invention, where the flange part (9b) is disk-shaped, flat on both the upper and lower surfaces, and has four semi-circular notches (9d) and the rod-shaped part (9a) has a constriction part (9c), the load required to pull out the hook (9) from the PTFE diaphragm (8), namely the hook pull-out load, was verified. Dimensions of the hook (9) of the diaphragm valve (1) in the present example used for the verification were: Diameter of rod-shaped part (9a): 4.5 mm; Diameter of flange part (9b): 7.5 mm; Diameter of constriction part (9c): 3 mm; Width of constriction part (9c): 2 mm; Diameter of semi-circular notch (9d): 2.4 mm. As a result of three measurements of the hook pull-out load of the diaphragm valve (1) in the present example, the average value of the measurement results was 56.3 kgf, as shown in Table 1 below.

On the other hand, as a result of three measurements of the pull-out load of a diaphragm of a comparative example with the same dimensions as the above hook (9) except that it does not have a constriction part (9c), the average value of the measurement results was 40.7 kgf, as shown in Table 1 below.

As is obvious from the results in Table 1, the hook pull-out load of the diaphragm valve in the present example (FIGS. 5-6) is increased by around 38% compared to the comparative example, which tells that the retention force of the flange part (9b) is surely increased.

TABLE 1

| | Example (kfg) | Comparative example (kfg) |
|---|---|---|
| No. 1 | 57.67 | 39.36 |
| No. 2 | 56.2 | 40.25 |
| No. 3 | 54.95 | 42.41 |
| Total | 168.82 | 122.02 |
| Average | 56.3 | 40.7 |
| | (38% increase) | |

Also, as for the diaphragm valve (1) in the present embodiment, even if the outer diameter of the flange part (9b) is φ7.2-φ7.7 mm, providing the lower end of the rod-shaped part (9a) with the constriction part (9c) as above enables the notch(es) (9d) of the flange part (9b) to be formed deeply in a radially inner direction of the flange part (9b). Therefore, it becomes possible to connect the component entering the constriction part (9c) and the component entering the notches (9d) in the component of the central part (8a) of the diaphragm (8) in more vicinity to the axial center of the rod-shaped part (9a) and the flange part (9b). As a result, even a small diaphragm valve (1) with a small diaphragm (8), where the outer diameter of the flange part (9b) embedded in the diaphragm (8) is as small as around φ7.2-φ7.7 mm, can easily increase the retention force of the flange part (9b). Therefore, even when a high pull-out load acts on the hook during regular sterilization by vapor for small diaphragms used in food industry vapor, it is possible to surely prevent the diaphragm (8) from coming off from the hook.

Furthermore, as for the diaphragm valve (1) in the present embodiment, the notches (9d) formed on the outer peripheral edge of the flange part (9b) are semi-circular shaped and made up of a smooth arc-shaped inner peripheral surface, thus, the component of the central part (8a) of the diaphragm (8) can enter inside the notches (9d) smoothly without any gap. Therefore, it is possible to surely increase the retention force of the flange part (9b) and reduce variability in performance of the diaphragm valve (1).

Also, as for the diaphragm valve (1) in the present embodiment, the central part (8a) of the lower surface of the flange part (9b) bulges downward, thus, when the diaphragm (8) closes the flow path and the hook (9) is lowered, the pressing force applied by the flange part (9b) to the central part (8a) of the diaphragm (8) is not concentrated on the outer peripheral edge of the flange part (9b), but can be distributed extensively inside the central part (8a). Therefore, it is possible to reduce the risk of deterioration and breakage of the diaphragm (8).

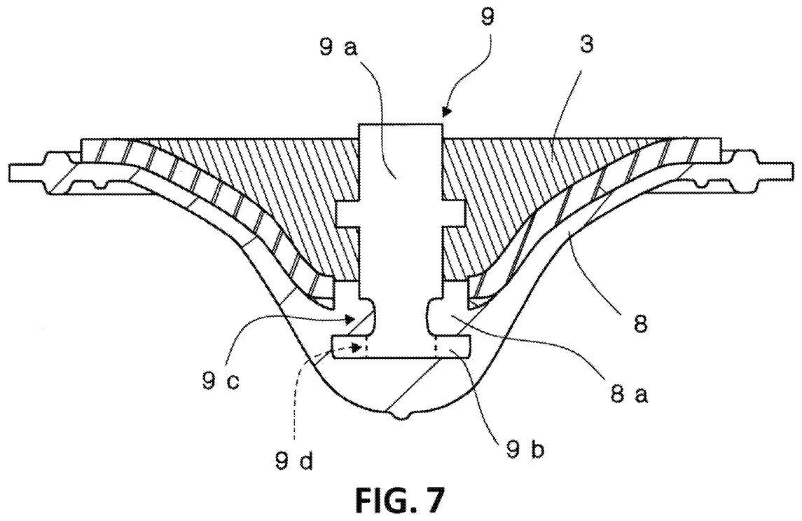

In another embodiment of the present invention, as shown in FIG. 7, it is preferable that the component of the central part (8a) of the diaphragm (8) is configured to cover the upper part of the constriction part (9c) of the rod-shaped part (9a) of the hook (9).

In this case, it becomes possible to increase the thickness of the component of the central part (8a) of the diaphragm (8) which is configured to cover the upper part of the flange part (9b), and it enables to further increase the retention force of the flange part (9b).

While the hook (9) shown in FIG. 7 has the same shape as the hook (9) shown in FIGS. 5-6, it may also have a shape of the hook (9) shown in FIGS. 3-4.

### INDUSTRIAL APPLICABILITY

The present invention is widely applicable to any diaphragm valve comprising a connecting member to connect a diaphragm to a diaphragm depressor and having a structure in which a flange part of the connecting member is embedded in the central part of the diaphragm, and can increase the effect of preventing the diaphragm from coming off from the connecting member.

### EXPLANATION OF SYMBOLS

1 Diaphragm valve

2 Valve body

3 Diaphragm depressor

4 Stem

5 Supporting member

6 Actuator cap

7 Spring

8 Diaphragm

8a Central part

9 Hook (Connecting member)

9a Rod-shaped part

9b Flange part

9c Constriction part

9d Notch

10 Inlet port

11 Air passage

21, 22 Flow path

23 Seat part

1. A diaphragm valve, comprising:
a body with a flow path;
a stem;
a diaphragm;
a diaphragm depressor which is attached to the lower end of said stem; and
a connecting member which connects said diaphragm and said diaphragm depressor, the diaphragm valve being able to open and close shutting off the flow path by deformation of the diaphragm,
wherein said connecting member has a rod-shaped part to be connected to said diaphragm depressor and a flange part which is radially protruding in a circular shape at the lower end of said connecting member and having at least one notch on the outer peripheral edge, and said rod-shaped part has a radially concaved constriction part above said flange part, and
wherein said flange part and said constriction part are embedded in the central part of said diaphragm.

2. The diaphragm valve of claim 1, wherein the outer diameter of said flange part is φ7.2-φ7.7 mm.

3. The diaphragm valve of claim 1, wherein said notch has a semi-circular shape.

4. The diaphragm valve of any one of claims 1 or 2, wherein said flange part has a shape where the central part of its lower surface bulges downward.

5. The diaphragm valve of any one of claims 1 or 4, wherein said constriction part is embedded in the central part of the diaphragm up to the upper part of said constriction part.

6. A diaphragm valve, comprising:
a body with a flow path;
a stem moveable up and down relative to said body;
a diaphragm which opens and closes the flow path in synchronization with the up-and-down movement of said stem;
a diaphragm depressor which is attached to the lower end of said stem and presses said diaphragm downward; and
a connecting member which connects the central part of said diaphragm to the lower part of said diaphragm depressor,
wherein said connecting member has a vertically placed rod-shaped part whose upper part is fixed to said diaphragm depressor and a flange part which is provided at the lower end of the rod-shaped part and protrudes radially outward of the outer peripheral surface of the rod-shaped part,
wherein the upper part of said flange part at the lower end of said rod-shaped part has a constriction part concaved radially inward,
wherein the outer peripheral edge of said flange part has at least one notch,
wherein the lower end of the rod-shaped part and said flange part of said connecting member are embedded in the central part of said diaphragm, and
wherein a component of the central part of the diaphragm is configured to cover both the upper and lower surfaces of the flange part by entering inside said constriction part of said rod-shaped part and said notch(es) of said flange part.

7. The diaphragm valve of claim 6, wherein the outer diameter of said flange part is φ7.2-φ7.7 mm.

8. The diaphragm valve of claim 6, wherein said notch has a semi-circular shape.

9. The diaphragm valve of any one of claims 6 or 7, wherein said flange part has a shape where the central part of its lower surface bulges downward.

10. The diaphragm valve of any one of claims 6 or 9, wherein the component of the central part of said diaphragm is configured to cover the upper part of said constriction part of said rod-shaped part.

11. The diaphragm valve of claim 2, wherein said notch has a semi-circular shape.

12. The diaphragm valve of claim 4, wherein said constriction part is embedded in the central part of the diaphragm up to the upper part of said constriction part.

13. The diaphragm valve of claim 7, wherein said notch has a semi-circular shape.

14. The diaphragm valve of claim 9, wherein the component of the central part of said diaphragm is configured to cover the upper part of said constriction part of said rod-shaped part.
